(19) United States
(12) Patent Application Publication
(10) Pub. No.: US 2026/0062538 A1
(43) Pub. Date: Mar. 5, 2026

(54) Composition Comprising an Alkyd Resin

(71) Applicant: Munditia Technologies GmbH, Giessen (DE)

(72) Inventor: Klaus SCHEPERS, Braunfels (DE)

(73) Assignee: Munditia Technologies GmbH, Giessen (DE)

(21) Appl. No.: 18/818,331

(22) Filed: Aug. 28, 2024

(51) Int. Cl. C08K 5/17; C08K 5/00; C08K 5/1535; C08K 5/5419; D06M 13/192; D06M 13/228; D06M 13/342; D06M 13/513; D06M 15/01; D06M 15/507

(52) U.S. Cl. CPC C08K 5/175; C08K 5/0008; C08K 5/1535; C08K 5/5419; D06M 13/192; D06M 13/228; D06M 13/342; D06M 13/513; D06M 15/01; D06M 15/507; C08K 2201/007; D10B 2401/13

(57) ABSTRACT

The present invention relates to a composition comprising an alkyd resin in combination with a complexing agent, an antioxidant, a fragrance, and/or an odor removal agent.

### BACKGROUND OF THE INVENTION

The present invention relates to a composition comprising an alkyd resin; and a complexing agent, an antioxidant, a fragrance, and/or an odor removal agent. It further relates to a method of preventing and/or suppressing malodor generated by degradation of an alkyd resin disposed on a substrate, said method comprising the step of applying the composition of the present invention to said substrate. The present invention further relates to a method for providing antimicrobial properties to a surface of a substrate, said method comprising the step of applying the composition of the present invention to at least part of said surface.

The use of alkyd resins is known in the art for several purposes, in particular in the synthetic coating and paint industry.

EP 3 426 739 discloses alkyd resins for providing antimicrobial properties, thereby also reducing offensive scents by reducing the growth of microbes. It is described that the alkyd resins can be applied to various substrates, such as textiles.

However, alkyd resins release an unpleasant scent over time.

Thus, there is still a need to provide compositions comprising an alkyd resin, which do not release an unpleasant scent over time and in particular which can be used as coating for textiles.

### SUMMARY OF THE INVENTION

It has been surprisingly found that a composition comprising an alkyd resin; and a complexing agent, an antioxidant, a fragrance, and/or an odor removal agent reduces or prevents unpleasant scents during long-term applications, in particular for textiles, such as woven and nonwoven fabrics. Applicant does not wish to be bound to any theory, but it is believed that alkyd resin degrades through autoxidation over time and releases volatile organic compounds, in particular volatile aldehydes, such as pentanal, hexanal, or heptanal, which lead to an unpleasant smell. The autooxidation is particularly pronounced in textiles due to the high porosity, which can increase the interaction with oxygen. The complexing agent and/or antioxidant reduces the autooxidation. The odor removal agents and/or fragrance can remove and/or mask the unpleasant odor.

Therefore, the present invention relates to a composition an alkyd resin; and a complexing agent, an antioxidant, a fragrance, and/or an odor removal agent.

Furthermore, the present invention relates to a method of preventing and/or suppressing malodor generated by degradation of an alkyd resin disposed on a substrate, said method comprising the step of applying the composition of the present invention to said substrate.

In a further aspect, the present invention relates to a method for providing antimicrobial properties to a surface of a substrate, said method comprising the step of applying the composition of the present invention to at least part of said surface.

### DETAILED DESCRIPTION OF THE PREFERRED EMBODIMENTS

The following general definitions are relevant in connection with the embodiments of the present invention.

The meaning of the term “comprising” is to be interpreted as encompassing all the specifically mentioned features as well optional, additional, unspecified ones, whereas the term “consisting of” only includes those features as specified. Therefore, “comprising” includes as a limiting case the composition specified by “consisting of”.

As used herein, singular forms, such as “a”, “an”, and “the”, include both singular and plural referents unless the context clearly dictates otherwise. By way of example, “an antioxidant” means one antioxidant or more than one antioxidant.

The term “wt. %” refers to the amount of the respective component by weight based on the total amount of the composition, unless noted otherwise.

It is to be understood that “a complexing agent, an antioxidant, a fragrance, and/or an odor removal agent” means “a complexing agent and/or an antioxidant and/or a fragrance and/or an odor removal agent”.

Preferred embodiments according to the invention are defined hereinafter. It is to be understood that the following embodiments refer to all aspects of the present invention, which includes the composition as well as the method of preventing and/or suppressing malodor and the method for providing antimicrobial properties to a surface.

In an embodiment, the invention relates to a composition comprising an alkyd resin; and a complexing agent, an antioxidant, a fragrance, and/or an odor removal agent.

### Additives

The term “antioxidant” refers to a compound that prevents or decreases oxidation. Non-limiting examples are polyphenols, such as quercetin, kaempferol, gallic acid, ellagic acid, ferulic acid, sinapic acid, chlorogenic acid, caffeic acid, protocatechuic acid, vanillic acid, tannic acid, anthocyanins, flavan-3-ols, and proanthocyanidins; vitamins, such as vitamin C, vitamin E, ascorbyl palmitate and vitamin A; carotenoids, such as lycopene, lutein, zeaxanthin, and astaxanthin; flavonoids, such as naringenin, hesperidin, eriodictyol, and taxifolin; phenolic acids, such as salicylic acid, cinnamic acid, benzoic acid, and hydroxybenzoic acid; coenzyme Q10, lipoic acid, acetyl-L-carnitine, tocopherol, propyl gallate (OPG), BHA, butylated hydroxytoluene (BHT), TBHQ; as well as salts, derivatives and/or mixtures thereof.

In a preferred embodiment, the antioxidant is selected from the class of polyphenols, vitamins, carotenoids, flavonoids, and mixtures thereof. In a particularly preferred embodiment, the antioxidant comprises vitamin C.

In a preferred embodiment, the composition comprises 0.01 wt.-% to 5 wt.-% antioxidant. In an embodiment the ratio (wt: wt) of alkyd resin to antioxidant is from 1000:1 to 50:1.

The term “odor removal agent” refers to a compound that can remove the odor, for example, by trapping the odor and/or reacting with the odor. Non-limiting examples comprise caffeine, coffee aroma, theobromine, kaempferol, catechins, α-cyclodextrin, β-cyclodextrin, γ-cyclodextrin, hydroxyapatite, polyalcohols and mixtures thereof. In an embodiment, the odor removal agent is selected from coffee, coffee aroma, cyclodextrins, polyalcohols, and mixtures thereof. Without being bound to theory, it is believed that cyclodextrins trap the odor molecules via intermolecular forces. Without being bound to theory, it is believed that the polyalcohols chemically bind to the aldehyde functional groups of the alkyd resin degradation products to form acetals.

The term complexing agent refers to a compound that binds metal ions. In an embodiment, the complexing agent is a complexing agent for heavy metal ions, such as copper, iron, zinc, or manganese ions. In an embodiment, the complexing agent is a chelating agent.

In a preferred embodiment, the complexing agent is selected from ethylenediaminetetraacetic acid, diethylenetriaminepentaacetic acid, ethylene glycol-bis(β-aminoethyl ether)tetraacetic acid, 1,2-bis(o-aminophenoxy)ethane-tetraacetic acid, ethylene diamine, nitrotriacetic acid, citric acid, tartaric acid, oxalic acid, malonic acid, succinic acid, glutaric acid, adipic fulvic acid, acid, catechol, nitrilotriacetic acid, hydroxyethylidene diphosphonic acid, lactic acid, gluconic acid, acetic acid, triphosphoric acid, phosphoric acid, 1,10-phenanthroline, 2,2′-bipyridine, hydroxychinoline, silicic acid, as well as salts thereof, and/or mixtures thereof. Non-limiting examples of suitable salts include sodium salts, potassium salts, calcium salts, ammonium salts, magnesium salts, and mixtures thereof. Non-limiting examples of the salts of EDTA (ethylenediaminetetraacetic acid) comprise diammonium EDTA, disodium EDTA, dipotassium EDTA, triammonium EDTA, trisodium EDTA, tripotassium EDTA, tetrasodium EDTA, tetrapotassium EDTA, and calcium disodium EDTA.

In a preferred embodiment, the composition comprises 0.01 wt.-% to 5 wt.-% complexing agent. In an embodiment the ratio (wt:wt) of alkyd resin to complexing agent is from 1000:1 to 50:1.

In an embodiment, the fragrance comprises an essential oil. In an embodiment, the essential oil is selected from jasmine oil, lily of the valley, chamomile oil, or rose oil, cedarwood oil, patchouli oil, sandalwood oil, frankincense oil, myrrh oil, benzoin oil, clove oil, cardamon oil, rosewood oil, vetiver oil, oregano oil, thyme oil, crypress oil, neroli oil, basil oil, rosemary oil, marjoram oil, ginger oil, fennel oil, black pepper oil, and mixtures thereof.

In a preferred embodiment, the essential oil has a boiling point higher than 150° C. Essential oils with a boiling point higher than 150° C. comprise cedarwood oil, patchouli oil, sandalwood oil, frankincense oil, myrrh oil, benzoin oil, clove oil, cardamon oil, rosewood oil, vetiver oil, oregano oil, thyme oil, crypress oil, neroli oil, basil oil, rosemary oil, marjoram oil, ginger oil, fennel oil, black pepper oil, and mixtures thereof.

In an embodiment, the fragrance comprises beta-isomethylionone, methyl lonone, iso E super, alpha-isomethylionone, citronellol, geraniol, nerol, citral, coumarin, dihydrocoumarin, ethyl coumarin, tonka bean absolute, hexyl cinnamal, amyl cinnamal, hexyl salicylate, limonene, terpineol, linalool, lavandulol, muguet, lilial, bourgeonal, linalyl acetate, isoeugenol, eugenol, methyleuganol, vanillin, benzyl salicylate, amyl salicylate, and/or phenyl salicylate. Suitable fragrances are described in the textbook “Scent and Chemistry: The Molecular World of Odors”, Ohloff et al., 2^{nd} ed., Wiley-VCH; 2022, which is incorporated herein by reference.

In a preferred embodiment, the fragrance comprises alpha-isomethylionone, citronellol, coumarin, hexyl cinnamal, limonene, linalool, isoeugenol, and/or benzyl salicylate.

In a preferred embodiment, the composition comprises an alkyd resin, an antioxidant and a complexing agent. In an even more preferred embodiment, the composition comprises an alkyd resin, vitamin C, and EDTA or a salt thereof.

In a preferred embodiment, the composition comprises an alkyd resin, an antioxidant a complexing agent, and an odor removal agent. In an even more preferred embodiment, the composition comprises an alkyd resin, vitamin C, EDTA or a salt thereof, and coffee aroma.

In an embodiment, the pH value of the composition is from 4.0 to 6.9, preferably from 4.5 to 6.5. it has surprisingly been found that a pH value that is slightly acidic can further slow the degradation of the alkyd resin and thereby prevent unpleasant odor.

The composition can further comprise a hydrophobing agent. Non-limiting examples of hydrophobing agents comprise siloxanes, and silicones, such as polydimethylsiloxane (PDMS), methylhydrosiloxane (MHS), and trimethylsilyl silicate.

### Alkyd Resin

The term “alkyd resin”, as used herein, refers to a polyester modified by the addition of fatty acids and/or other components. Alkyd resins are derived from a di-, tri- or polyol and a di-, tri- or polycarboxylic acid or carboxylic acid anhydride. The monomers as such are not encompassed by the term “alkyd resin”.

The di-, tri- or polyacid can for example be selected from the group consisting of oxalic acid, malonic acid, succinic acid, glutaric acid, adipic acid, pimelic acid, suberic acid, azelaic acid, cebacic acid, maleic acid, fumaric acid, glutaconic acid, malic acid, aspartic acid, glutamic acid, tartaric acid, phthalic acid, isophthalic acid, terephthalic acid and/or mixtures thereof. Anhydrides of these acids are also suitable. Preferably, the acid residue in the polyester is a diacid residue.

The di-, tri- or polyalcohol can for example be selected from the group consisting of ethylene glycol, butylene glycol, pentanediol, neopentyl glycol, hexylene glycol, diethylene glycol, dipropylene glycol, triethylene glycol, glycerol, trimethylolethane, trimethylopropane, pentaerythritol, methylglucoside, sugars, sugar alcohols, such as mannitol, xylitol and sorbitol and/or mixtures thereof.

In an embodiment, the composition comprises 0.1 to 70 wt.-% alkyd resin, preferably 1 to 60 wt.-% alkyd resin.

The polyester backbone in the alkyd resin can be modified by any organic residue, preferably a hydrophobic residue, more preferably a hydrophobic residue which does not contain any additional reactive groups as defined below. Preferably, the polyester is modified with an acid residue, more preferably with a fatty acid residue.

The term “fatty acid” refers to a carboxylic acid having an aliphatic chain. In one embodiment, the aliphatic chain is saturated. In another embodiment, the aliphatic chain is unsaturated. The number of C-atoms in the aliphatic chain can be in the range from 1 to 40 C-atoms, preferably 1 to 26 C-atoms or 1 to 18 C-atoms. Even more preferably the number of C-atoms in the aliphatic chain is at least 6, such as at least 10 or at least 15. More preferably the number of C-atoms in the aliphatic chain is in the range of 6 to 40, 6 to 26, 6 to 20, 10 to 40, 10 to 26, 10 to 20, 15 to 40, 15 to 26 or 15 to 20; 15 to 20 being particularly preferred.

Preferably, the fatty acid is selected from the group consisting of caproic acid, caprylic acid, capric acid, myristoleic acid, palmitoleic acid, sapienic acid, oleic acid, elaidic acid, vaccenic acid, linoleic acid, linoelaidic acid, α-linolenic acid, arachidonic acid, palmitic acid, stearic acid, lauric acid, myristic acid and/or combinations thereof. In another embodiment, the fatty acid can be di- or trifunctional and is selected from the list consisting of adipic acid, fumaric acid, isophthalic acid, maleic acid, phthalic acid, succinic acid, citric acid and/or combinations thereof. In a further embodiment, the fatty acid is an anhydride of the above named fatty acids.

In one embodiment, the alkyd resin is a linear polyester. A linear polyester, as defined herein is a difunctional molecule and has two reactive sites.

In another embodiment, the alkyd resin is a branched polyester containing fatty-acid side groups. A branched polyester, as defined herein is a tri-, tetra-, or higher functional molecule and has three, four, or more reactive sites. Branched polyester may form, as linear polyester, molecular chains, but, in addition, branching connections are formed, which result in a three-dimensional network (cross-linking).

In one embodiment, the alkyd resin is further modified with an unsaturated or saturated oil or the alkyl resin contains such oil.

Preferably, the unsaturated or saturated oil is selected from the group consisting of tung oil, linseed oil, sunflower oil, safflower oil, walnut oil, soybean oil, fish oil, canola oil, tall oil, dehydrated castor oil, coconut oil, rapeseed oil, peanut oil, peppermint oil, lavender oil, safflower oil, palm oil, walnut oil, fish oil, corn oil, tall oil, sesame oil, dehydrated castor oil, cumin oil, flax oil, vernonia oil jatropha oil, kenaf oil, mustard oil, gnee oil and/or mixtures thereof. Linseed oil, sunflower oil, coconut oil, rapeseed oil, peppermint oil, lavender oil and soybean oil, safflower oil, walnut oil, fish oil, corn oil, tall oil, palm oil, dehydrated castor oil, cumin oil, flax oil, and vernonia oil being particularly preferred.

The above ois can be present in the alkyd resin as such or as derivatives thereof, for example as their fatty acid, monoester, fatty acid diester, and esters with other carboxylic acids, such as ascorbic acid, acetic acid, propionic acid, benzoic acid or lactic acid.

Further possible additives in the alkyd resin are for example fatty acids, in particular those as described above, oct-1-en-3-ol, citronellal and pheromones of clothing mots, such as for example (Z, E)-tetradeca-9,12-dienyl acetate.

Alkyd resins comprising an unsaturated or saturated oil are classified by the amount of oil based on the total weight of the resin. In one embodiment, the amount of unsaturated or saturated oil is higher than 60 wt.-% (long-oil alkyd resin), between 40 wt.-% and 60 wt.-% (medium-oil alkyd resin), or lower than 40 wt.-% (short-oil alkyd resin) based on the total weight of the alkyd resin. In a preferred embodiment the alkyd resin is a medium-oil alkyd resin or a long-oil alkyd resin.

In one embodiment, the alkyd resin is a drying or a non-drying alkyd resin.

In a preferred embodiment, the alkyd is a crude alkyd comprising fatty acid residues, which contain at least 6 carbon atoms in the saturated or unsaturated aliphatic chain and no reactive functional group, wherein the cured alkyd resin is free of any biocidal product as defined in Article 3(1)(a) of the Regulation (EU) No. 528-2012 of the European Parliament and the Counsel of 22 May 2012.

In a preferred embodiment, the alkyd resin is Mundex W 955 Plus 11 (Munditia Technologies GmbH) or Mundex W 955 Plus 81 (Munditia Technologies GmbH). In one embodiment the alkyd resin is WorleeKyd B 845 (Worlée-Chemie GmbH, Germany), Setal 196 XX (Nuplex, USA, Kentucky) or Alkydal F26 XX, Alkydal F251 X (Covestro, Germany).

In an embodiment, the present invention relates to a method of preventing and/or suppressing malodor generated by degradation of an alkyd resin disposed on a substrate, said method comprising the step of applying the composition of the present invention to said substrate.

### Substrate

The term “substrate”, as referred to herein, includes bodies of any material, including for example a textile, polymer body, a paint, a varnish, a coating, an ink, glass fibers and an inorganic oxide material, containers for storage of drinking water (e.g. in the beverage industry), waste water, or surface water; containers for waste decomposition; containers for water purification; hospitals, medical equipment and devices, wound dressings, diapers, household appliances, water boilers, heating systems, slaughterhouses, ships, boats, roof coverings, roof tiles, indoor tiles, outdoor tiles, kitchen rooms, sinks, bathroom equipment, wash closets, toilets, portable toilets, ceramics, polymers, fibers, rain water sewers, exterior façades, elements of façades, pools, pumps, tubing, walls, floorings, laminates, paper, wood, apparatus for air and water purification, apparatus for soil decontamination, window glass (e.g. self-cleaning windows), mirrors (e.g. anti-fog coatings for mirrors and/or glass), filter materials such as nonwovens, respirator masks, air filters, such as air-conditioner filters, water filters, and activated-carbon filters for water, air purification, and/or (food) packaging. In a preferred embodiment, the substrate is a textile, a filter, or a membrane. In a particularly preferred embodiment, the substrate comprises a textile.

In a preferred embodiment, the textile comprises clothing, such as activewear, sportswear, or workwear, bed linen, nonwoven filters, such as air filters, air conditioning filters, or water filters, and/or medical textile, such as wound dressings. In a preferred embodiment, the textile is for clothing, such as activewear, sportswear, or workwear, bed linen, nonwoven filters, such as air filters, air conditioning filters, or water filters, and/or medical textile, such as wound dressings.

The term “textile” encompasses inter alia nonwoven, felted, knitted and woven fabrics. The textile can be used for a variety of purposes, such as clothing, industrial purposes, furnishing, (bio) medical applications, and filter systems. The textile can comprise natural textile, synthetic textile, blended textile and specialty textile.

Natural textile includes cotton, linen, wool, silk, hemp, cashmere. Synthetic textile includes polyester, polyamides (e.g. nylon and/or perlon), PVC, polypropylene, viscose, polyurethanes, elastane, aramid, rayon, modal, lyocell, cupro and acrylics. Blended textile comprises blends of polyester-cotton, wool-acrylic, silk-cotton, linen-cotton. Specialty textile includes denim, tweed, velvet, satin, canvas.

The bodies may have any shape including for example plates, sheets, fibers and tubes. It is preferred that the substrate is a porous substrate.

The above described qualities of the composition can be used to modify surfaces of substrates. Wherein one or more parts (e.g. materials, additives, surface layers, inner layers, exterior, interior, etc.) of the said substrate has been applied with the composition described herein, and/or one or more of the surfaces (e.g. functional surfaces) of the said substrate are at least partially coated with surface layers, paints or coatings, wherein said surface layers, paints or coatings have been applied with the composition of the present invention.

The composition can be applied directly to said substrate. Alternatively, the composition can be diluted to provide a diluted composition, which is subsequently applied to said substrate.

The term “applied” refers to any suitable method for bringing the composition of the present invention into contact with the substrate and encompasses the impregnation of the substrate by immersing the substrate in the composition or a diluted form of the composition, spraying of the composition, coating with a doctor knife, splashing, or padding with a textile padding machine. For textiles, the composition can advantageously be applied to the substrate during dying of the textile.

The present invention also relates to a substrate that has been applied with the composition of the present invention. Preferably, the present invention relates to a textile coated with the composition of the present invention. Preferably, the present invention relates to a textile impregnated with the composition of the present invention.

### Method for Providing Antimicrobial Properties

In an embodiment, the invention relates to a method for providing antimicrobial properties to a surface of a substrate, said method comprising the step of applying the composition of the present invention to at least part of said surface.

The antimicrobial properties include antibacterial, disinfecting, antifouling and/or self-sanitizing properties.

The term “antimicrobial”, as used herein, refers to the ability of the alkyd resin to kill microorganisms.

The term “microorganism”, as referred to herein, includes bacteria, viruses, fungi and algae. Preferably, the term “microorganism”, as used herein, refers to bacteria.

The ability to kill microorganisms results in disinfecting, antifouling, self-sanitizing and and/or biocidal effects. In this context “antifouling” refers to the ability to prevent or remove biofouling on wetted surfaces. Biofouling is the accumulation of microorganisms, plants, algae or animals on wetted surfaces and killing such microorganisms, including algae, supports the prevention or removal of biofouling.

A particular advantage of the use, according to the present invention, is the finding that alkyd resins itself without the requirement of any further biocidally acting compound provides the desired antimicrobial effect. Therefore, in a particularly preferred embodiment of the present invention the alkyd resin is free of any additional antimicrobial compound, in particular free of any biocidal product as defined in Article 3(1)(a) of the Regulation (EU) No. 528-2012 of the European Parliament and the Counsel of 22 May 2012. In particular, the alky resin used in the present invention does not contain any nanoparticles, such as metal nanoparticles, in particular silver nanoparticles. Preferably the alkyd resin is free of silver, organotin and gum rosin.

In further embodiment the alkyd resin used according to the present invention does not contain any internal biocides, preferably the alkyd resin does not contain any internal biocides and any external biocides. In this context “internal biocides” are understood as compounds having biocidal activity (in particular those compounds as defined in Article 3(1)(a) of the Regulation (EU) No. 528-2012 of the European Parliament and the Counsel of 22 May 2012), which are chemically bound to the alkyd resin, such as the gum rosin in the alkyd resin of example 1 of WO 2010/040903 or the organotin compound in the alkyd resin of U.S. Pat. No. 4,039,494. “External biocides” are to be understood as those biocidal compounds which are present in the alkyd resin, but which are not chemically bound to the alkyd polymer.

Since it is believed that the antimicrobial effect of the alkyd resin is due to a mechanical interaction between the hydrophobe fatty acid residue side chains of the polyester polymer and the cell membranes of for example bacteria, it is desirable that the fatty acid residues have a certain hydrophobicity but do not react with the cell membranes. It is therefore preferred that the fatty acid residues in the alkyd resins do not contain any reactive functional groups, such as hydroxy, amino, sulfo, phosphato, carboxy, carboxy-amid, cyano, etc. Possible unsaturations in the fatty acid residues are not considered as reactive functional groups in the sense of the present invention.

In one embodiment, the alkyd resin additionally reduces the growth of a biofilm on the surface of the substrate. The term “additionally” as used herein has the meaning of “simultaneously” and/or “sequentially”. The term “biofilm”, as used herein, refers to an assembly of microorganisms wherein cells stick to each other on the surface of a substrate. The term “growth of biofilm” or “biofilm growth”, as used herein, refers to the microorganism built-up adhering to a surface of a substrate.

The term “reduction of the growth of a biofilm”, as used herein, refers to the decrease, preferably the inhibition, of the microorganism built-up on a long term scale, i.e. at least 1 week, preferably at least 1 month, more preferably at least 1 year, even more preferably at least 3 years, on the surface of a substrate comprising an alkyd resin as described herein compared to the surface of a substrate not comprising an alkyd resin as described herein.

In one embodiment of the present invention the alkyd resin is further combined with a polymer such as a thermoplastic polymer, an elastomer, a thermoplastic elastomer, a duroplast or a mixture thereof.

### EXAMPLES

### Example 1 (Comparative Example)

A composition comprising an alkyd resin was impregnated on fabric and the odor was tested.

6.5 g Mundex W 955 Plus 81 (24% dry matter content) was diluted with water to 150 g, then the cotton fabric was immersed and stored vertically for 60 seconds. The fabric was then dried for 150 s at 150° C. The application concentration of alkyd resin was 1.8%.

A blind odor test according to SNV 195 651 was conducted by an external textile testing institute (Hohenstein Textile Testing Institute). An odor score of 3.6 (strong odor) was obtained. The odor score ranges from 1 to 5, wherein a score of 1 corresponds to no odor, a score of 2 to faint odor, a score of 3 to medium odor, a score of 4 to strong odor, and a score of 5 to very strong odor.

### Example 2 (Comparative Example)

A composition comprising an alkyd resin was impregnated on fabric and the odor was tested.

7.5 g Mundex W 955 Plus 11 (21% dry matter content) was diluted with water to 150 g, then the cotton fabric was immersed and stored vertically for 60 seconds. The fabric was then dried for 150 s at 150° C. The application concentration of alkyd resin was 1.7%.

The blind odor test according to SNV 195 provided a score of 3.6 (strong odor).

### Example 3

A composition was prepared comprising 500 g Mundex W 955 Plus 11 (21% dry matter content), 0.4 g EDTA tetrasodium salt and 0.5 g vitamin C.

7.5 g of said composition were diluted with water to 150 g, then the cotton fabric was immersed and stored vertically for 60 seconds. The fabric was then dried for 150 s at 150° C. The application concentration of alkyd resin was 1.7%.

The blind odor test according to SNV 195 provided a score of 2.8.

### Example 4

A composition comprising 500 g Mundex W 955 Plus 81 (24% dry matter content),0.4 g EDTA disodium salt, and 1 g vitamin C was prepared.

6.5 g of said composition was diluted with water to 150 g, then the cotton fabric was immersed and stored vertically for 60 seconds. The fabric was then dried for 150 s at 150° C. The application concentration of alkyd resin was 1.7%.

The blind odor test according to SNV 195 provided a score of 2.6.

### Example 5

A composition comprising 500 g Mundex W 955 Plus 81 (24% dry matter content), 0.4 g EDTA disodium salt, 2.5 g vitamin C, and 1.5 g coffee flavoring was prepared.

6.5 g of said composition was diluted with water to 150 g, then the cotton fabric was immersed and stored vertically for 60 seconds. The fabric was then dried for 150 s at 150° C. The application concentration of alkyd resin was 1.7%.

The blind odor test according to SNV 195 provided a score of 1.8.

### Example 6

A composition comprising 500 g Mundex W 955 Plus 11 (21% dry matter content), 0.4 g EDTA disodium salt, 2.5 g vitamin C, and 1.5 g coffee flavoring was prepared.

7.5 g of said composition was diluted with water to 150 g, then the cotton fabric was immersed and stored vertically for 60 seconds. The fabric was then dried for 150 s at 150° C. The application concentration of the alkyd resin was 1.7%.

The blind odor test according to SNV 195 provided a score of 1.8.

### Example 7

A composition comprising 500 g Mundex W 955 Plus 11 (50% dry matter content), 0.4 g citronellol, 0.4 g limonene, and 0.4 g linalool was prepared.

8.0 g of said composition was diluted with water to 250 g, then the cotton fabric (stretch cotton) was immersed and stored vertically for 60 seconds. The fabric was then dried for 150 s at 150° C. The application concentration of the alkyd resin was 3.2%.

With an organoleptic odor test of the fabric after 4 days and 14 days after drying a very faint scent of fragrances could be perceived; an inherent odor due to the alkyd resin could not be detected.

### Example 8

A composition comprising 500 g Mundex W 955 Plus 11 (50% dry matter content), 0.20 g alpha-isomethylionone, 0.20 g citronellol, 0.20 g coumarin, 0.20 g hexyl cinnamal, 0.20 g limonene, 0.20 g linalool, and 0.25 g isoeugenol was prepared.

8.0 g Mundex W 955 Plus 81 of said composition was diluted with water to 250 g, then the cotton fabric (stretch cotton) was immersed and stored vertically for 60 seconds. The fabric was then dried for 150 s at 150° C. The application concentration of the alkyd resin was 3.5%.

With an organoleptic odor test of the fabric at 4 days and 14 days after drying a very faint scent of fragrances could be perceived; an inherent odor due to the alkyd resin could not be detected.

### Example 9

A composition comprising an alkyd resin and fragrance was padded on fabric and the odor was tested.

A composition comprising 10 kg Mundex W 955 Plus 11 (50% dry substance content), 4 g alpha-isomethylionone, 5 g citronellol, 5 g hexyl cinnamal, 5 g limonene, 5 g benzyl salicylate was prepared.

6.3 kg of said composition was diluted with water to 100 I in a padder.

A polyester/cotton fabric was then pulled through the bath (liquid absorption: 61%) and squeezed in the padder at a pressure of 3 bar. This was followed by drying for 150 s at 150° C.

With an organoleptic odor test of the fabric at 4 days and 14 days after drying a very faint scent of fragrances could be perceived; an inherent odor due to the degradation of alkyd resin could not be detected.

The results are summarized in the following table:

TABLE 1

| Example | Composition | Application | Odor |
|---|---|---|---|
| 1 | alkyd resin | impregnation | 3.6* |
| 2 | alkyd resin | impregnation | 3.6* |
| 3 | alkyd resin, complexing | impregnation | 2.8* |
| | agent, antioxidant | | |
| 4 | alkyd resin, complexing | impregnation | 2.6* |
| | agent, antioxidant | | |
| 5 | alkyd resin, complexing | impregnation | 1.8* |
| | agent, antioxidant, | | |
| | odor removal agent | | |
| 6 | alkyd resin, complexing | impregnation | 1.8* |
| | agent, antioxidant, | | |
| | odor removal agent | | |
| 7 | alkyd resin, fragrance | impregnation | pleasant olfactory |
| | | | perception |
| 8 | alkyd resin, fragrance | impregnation | pleasant olfactory |
| | | | perception |
| 9 | alkyd resin, fragrance | padding | pleasant olfactory |
| | | | perception |

*score from 1 to 5, wherein 1 denotes no odor and 5 denotes strong odor.

It can be seen from the data in the above table that the unpleasant odor of alkyd resins when applied to textiles can be reduced by using a complexing agent, antioxidant, odor removal agent, and/or fragrance.

1. A composition comprising an alkyd resin in combination with one or more of a complexing agent, an antioxidant, a fragrance, and an odor removal agent.

2. The composition according to claim 1, wherein the composition includes an odor removal agent selected from the group consisting of: coffee, coffee aroma, cyclodextrins, and polyalcohols, and mixtures thereof.

3. The composition according to claim 1, wherein the composition includes a complexing agent selected from the group consisting of: ethylenediaminetetraacetic acid, diethylenetriaminepentaacetic acid, ethylene glycol-bis(β-aminoethyl ether)tetraacetic acid, 1,2-bis(o-aminophenoxy)ethane-tetraacetic acid, ethylene diamine, nitrotriacetic acid, citric acid, tartaric acid, oxalic acid, malonic acid, succinic acid, glutaric acid, adipic acid, fulvic acid, catechol, nitrilotriacetic acid, hydroxyethylidene diphosphonic acid, lactic acid, gluconic acid, acetic acid, triphosphoric acid, diphosphoric acid, phosphoric acid, metaphosphoric acid, 1,10-phenanthroline, 2,2′-bipyridine, hydroxychinoline, and silicic acid and salts and mixtures thereof.

4. The composition according to claim 1, wherein the composition includes an antioxidant selected from the group consisting of: polyphenols, vitamins, carotenoids, flavonoids, phenolic acids, ubiquinone, lipoic acid, acetyl carnitine, butylated hydroxytoluene, butylated hydroxyanisole, and tert-butylhydroquinone, and mixtures thereof.

5. The composition according to claim 1, wherein the alkyd resin comprises a fatty acid residue that contains at least six carbon atoms in a saturated or unsaturated aliphatic chain.

6. The composition according to claim 1, wherein the alkyd resin is a polyester modified with fatty acids.

7. The composition according to claim 6, wherein the alkyd resin is a linear polyester.

8. The composition according to claim 6, wherein the alkyd resin is a branched polyester containing fatty-acid side groups.

9. The composition according to claim 1, wherein the alkyd resin is further modified with or contains an unsaturated or saturated oil.

10. The composition according to claim 9, wherein the unsaturated or saturated oil is selected from the group consisting of: tung oil, linseed oil, sunflower oil, safflower oil, walnut oil, soybean oil, fish oil, canola oil, tall oil, dehydrated castor oil, coconut oil, rapeseed oil, peanut oil, peppermint oil, lavender oil, safflower oil, palm oil, walnut oil, fish oil, corn oil, tall oil, sesame oil, dehydrated castor oil, cumin oil, flax oil, vernonia oil jatropha oil, kenaf oil, mustard oil, and gnee oil and mixtures thereof

11. The composition of claim 10, wherein the amount of unsaturated or saturated oil is higher than 60 wt.-% if a long-oil alkyd resin, between 40 wt.-% and 60 wt.-% if a medium-oil alkyd resin, or lower than 40 wt.-% if a short-oil alkyd resin, based on the total weight of the alkyd resin.

12. The composition according to claim 1, wherein the composition further comprises a hydrophobing agent.

13. The composition according to claim 1, wherein the composition include a fragrance comprising an essential oil.

14. The composition according to claim 13, wherein the essential oil has a boiling point higher than 150° C.

15. The composition according to claim 14, wherein the essential oil is selected from the group consisting of: cedarwood oil, patchouli oil, sandalwood oil, frankincense oil, myrrh oil, benzoin oil, clove oil, cardamon oil, rosewood oil, vetiver oil, oregano oil, thyme oil, crypress oil, neroli oil, basil oil, rosemary oil, marjoram oil, ginger oil, fennel oil, and black pepper oil, and mixtures thereof.

16. The composition according to claim 1, wherein said composition does not contain a biocidal compound and/or the alkyd resin is not chemically bound to a biocidal compound.

17. A method of preventing and/or suppressing malodor generated by degradation of an alkyd resin disposed on a substrate, said method comprising the step of applying the composition of claim 1 to said substrate.

18. A method for providing antimicrobial properties to a surface of a substrate, said method comprising the step of applying the composition of claim 1 to at least part of said surface.

19. The method of claim 18, wherein the antimicrobial properties include antibacterial, disinfecting, antifouling and/or self-sanitizing properties.

20. The method of claim 17, wherein the substrate is selected from the group consisting of: a textile, a membrane, a polymer body, a paint, a varnish, a coating, an ink, glass fibers and an inorganic oxide material.
